(19) United States
(12) Patent Application Publication
(10) Pub. No.: US 2006/0011682 A1
(43) Pub. Date: Jan. 19, 2006

(54) Load stabilizing device

(76) Inventors: Joseph W. Christensen, Cedar Hills, UT (US); Jason Tippetts, Hiusbord, OR (US); Michael J. Pratt, Draper, UT (US)

Correspondence Address: KIRTON AND MCCONKIE;1800 EAGLE GATE TOWER, 60 EAST SOUTH TEMPLE, P O BOX 45120, SALT LAKE CITY, UT, 84145-0120, US

(21) Appl. No.: 11/171,739

(22) Filed: Jun. 30, 2005

Related U.S. Application Data
(60) Provisional application No. 60/585,741, filed on Jul. 6, 2004.

(51) Int. Cl. B60R 9/00; B60R 11/00

(52) U.S. Cl. 224/274; 224/572

(57) ABSTRACT

A device capable of quickly and easily stabilizing a load with respect to an associated cart or carrier to facilitate load transport.

### RELATED APPLICATION

This application claims priority to U.S. Provisional Paten Application Ser. No. 60/585,741, filed on Jul. 6, 2004, and entitled “LOAD STABILIZING DEVICE.”

### BACKGROUND

1. Field of the Invention

This invention relates to methods and devices for securing a load to facilitate its transport, and particularly to methods and devices for stabilizing a bag against an associated cart or carrier to prevent bag imbalance or content damage during transport.

2. Background

Golf is one of the most widely enjoyed sports activities in the world, and has strong support at both the recreational and professional levels. While golf has always been a popular game for both novices and professionals, the popularity of the game has exploded in recent years. Record numbers are flocking to beautiful courses worldwide to try their hand at the seemingly arduous task of putting a little white ball in a four inch hole located hundreds of yards away in as few shots as possible.

During play, golfers must transport several different clubs, balls, tees, and other accessories a considerable distance. As a result, a golf bag has become an indispensable part of any golfer's inventory. As a fully loaded golf bag is both heavy and bulky, a motorized golf cart or carrier with wheels is often used to enable a golfer to transport the bag with minimal physical strain. Methods and devices for securing a golf bag to a cart or other carrier are well known in the art. U.S. Pat. No. 5,871,183, for example, teaches golf bag strapping and strapping systems for golf bag carriers.

Despite their efficacy in securing a golf bag to its associated cart or carrier, however, known securing devices generally fail to ensure that a bag remains properly balanced during transport. Golf bags pose particular balancing problems due to their cylindrical shape. Prior art securing systems generally require a strap extending around a circumference of the bag and connected to an associated cart or carrier. Such systems thus effectively secure the bag to the carrier, but ignore the tendency of the bag to rotate within the strap. Bag rotation may cause a shift in bag contents, thus resulting in load imbalance and potentially impacting the balance of the cart or carrier generally.

This problem is exacerbated by transport over rough or uneven terrain, such as that typically encountered on a golf course. Indeed, transport over uneven terrain tends to further disturb the equilibrium between the bag and its carrier. The resulting uneven distribution of weight both within the bag and with respect to the carrier may damage the bag and bag contents, and may even cause the cart or carrier to topple. In extreme circumstances, load imbalance may cause personal injury to the operator of the cart or carrier where he or she fails to anticipate or counteract the imbalance.

Accordingly, what is needed is a load securing device capable of preventing load imbalance during transport. What is also needed is a load securing device that is inexpensive to manufacture and simple to implement. Finally what is needed is a load securing device that is reliable and capable of effectively stabilizing loads of various sizes and shapes relative to an associated cart or carrier.

Such devices and methods are disclosed and claimed herein.

### SUMMARY

The present invention is a device capable of quickly and easily stabilizing a load with respect to an associated cart or carrier to facilitate load transport.

In accordance with the invention as embodied and broadly described herein, the present invention features a flexible band extending from one point of attachment to a second point of attachment located on a surface of the load. Specifically, the device of the present invention may comprise an elastic perforated strap capable of expanding to accommodate the width or circumference of a securing bar located on an associated cart or carrier.

According to another aspect of the present invention, the device may further include attachment means capable of selective engagement with the load surface. In certain embodiments, the device is permanently attached to the load at one point of attachment and removably attached at the second point of attachment. Alternatively, the device may be removably attached at both points of attachment. In either case, the points of attachment are located on the surface of the load such that, upon implementation of the present device, the load maintains a proper balance with respect to its associated cart or carrier. A user may selectively implement the device by extending the device from the first point of attachment to the second point of attachment, over the securing bar of the associated carrier or cart. In this manner, the device of the present invention prevents imbalance between the load and its carrier.

These and other features and advantages of the present invention will be set forth or will become more fully apparent in the description that follows. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is an isolated perspective view of a load stabilizing device in accordance with certain embodiments of the present invention;

FIG. 2 is a perspective view of the load stabilizing device of FIG. 1 implemented in connection with a golf bag and associated motorized golf cart;

FIG. 3 is a perspective view of an alternative embodiment of the present invention in connection with a golf bag and associated manually operated carrier;

FIG. 4 is a perspective view of a third embodiment of the present invention implemented in connection with a golf bag and associated motorized golf cart;

FIG. 5 is a perspective view of a fourth embodiment of the present invention; and

### DETAILED DESCRIPTION OF THE INVENTION

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The presently preferred embodiments of the invention will be best understood by reference to the drawings wherein like parts are designated by like numerals throughout.

As used in this specification, the term “carrier” refers to a motorized vehicle, a manually transportable cart, a trailer, or any other piece of equipment capable of receiving and transporting a load. The term “load” refers to a mass or quantity of material of any type, size, or shape that may be secured to and transported by a carrier. A load may include, for example, any bag, container, box, sack, pack, or similar structure or device.

The present invention features a retaining strap capable of restricting relative movement between a load and its associated carrier.

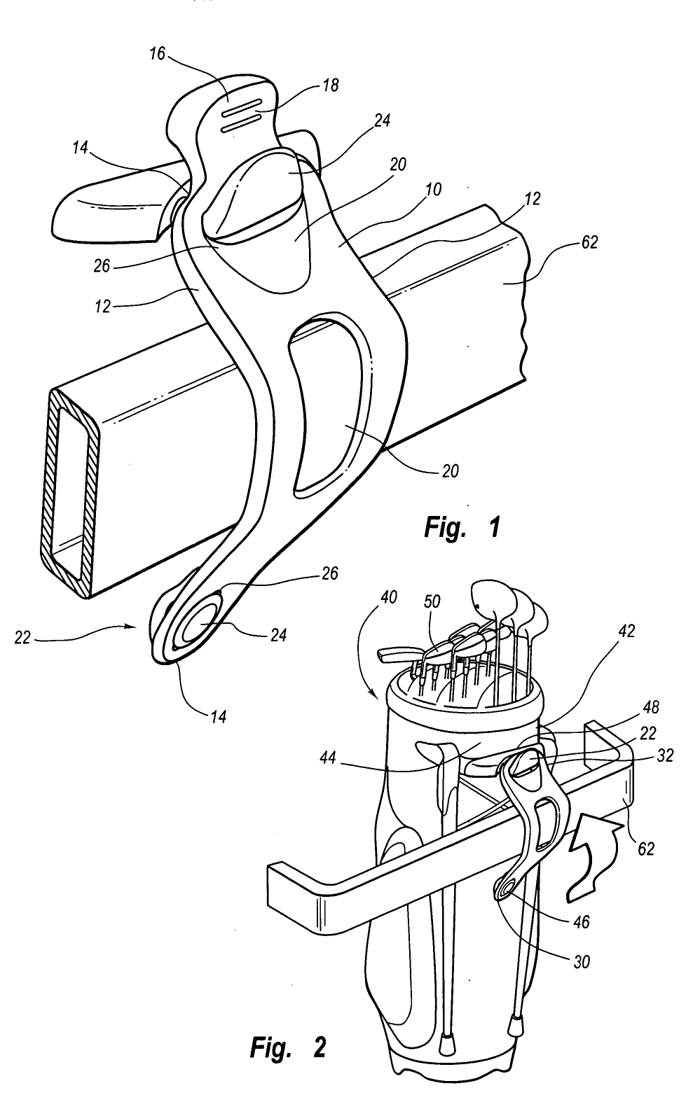

Referring to FIG. 1, a retaining strap 10 may comprise an elongate member having a length preferably between six and twelve inches, and having tensile properties capable of preventing relative movement between a load 40 and a carrier 60. A retaining strap 10 may comprise, for example, metal, wood, plastic, rubber, leather, or any other rigid or elastomeric material known to those in the art having properties capable of stabilizing a load 40 with respect to its carrier 60. Preferably, a retaining strap 10 is capable of quickly and effectively restricting movement of a load 40 with respect to a securing bar 62 of a carrier 60 as disclosed herein, and is also capable of quickly recovering its former shape upon release. A retaining strap 10 in accordance with the present invention may comprise, for example, a band, a spring, a bracket, a rope, a belt, a chain, or any other such mechanism or device known to those in the art.

According to one aspect of the present invention, a retaining strap 10 may comprise a substantially flat, elongate material having sides 12 and ends 14. A semi-fixed end 30 may be first secured to the load 40 at a principle point of attachment 46, and a detachable end 32 may be guided over or around a securing bar 62 of an associated carrier 60 and secured to a secondary point of attachment 48, as discussed in more detail with reference to FIG. 2 below. The sides 12 of the retaining strap 10 may taper such that the second end 32 has a width greater than the first end 30. In this manner, a user may easily grasp the second, enlarged end 32 to effectuate coupling and releasing the device of the present invention. The enlarged nature of the second releasable end 32 is particularly helpful where the retaining strap 10 of the present invention must be significantly stretched to accommodate and confine the securing bar 62 of the carrier 60. Indeed, such increased surface area enables a user to confidently apply a significant level of force to effectuate use of the present invention without fear of losing grasp of the retaining strap 10 and causing it to recoil against, and possibly injure, the user.

To further facilitate actuating the retaining strap 10 in accordance with the present invention, the second releasable end 32 of the retaining strap 10 may optionally comprise a pull tab 16 integral to the retaining strap 10, or attached thereto. Where the pull tab 16 is integral to the retaining strap 10, the pull tab 16 may comprise the same or a similar material as the retaining strap 10. Alternatively, the pull tab 16 may comprise a material distinct but integrated into the retaining strap 10.

A pull tab 16 in accordance with the present invention may comprise a length, a width, and a depth. The pull tab 16 preferably comprises a length and width sufficient to accommodate the thumb of an average user to facilitate a user's ability to maintain leverage of the pull tab 16 and associated retaining strap 10. In certain embodiments of the present invention, a pull tab 16 may comprise a depth greater than a depth corresponding to the retaining strap 10 to facilitate a user's ability to grasp the tab 16 to effectuate proper securing of the stabilizing device of the present invention. A pull tab 16 may also comprise a textured grip portion 18 to further facilitate this purpose. A textured grip portion 18 may comprise ridges, indents, or other texture integral to the pull tab 16. Alternatively, a textured grip portion 18 may comprise one or more textured elements coupled thereto, such as embedded beads, ridges, or grids, textured fabric, or any other textured element or combination of elements known to those in the art. The dimensions and textures of the pull tab 16 as disclosed herein combine to render the present invention quickly and easily actuated by a user.

A retaining strap 10 may further comprise one or more apertures 20 disposed therein. Apertures 20 may function to increase flexibility and elasticity of the retaining strap 10. In addition, apertures 20 may provide drainage and/or circulation to the load 40.

A retaining strap 10 may further comprise attachment means 22 for securing the retaining strap 10 to a load 40. Specifically, attachment means 22 may comprise an engaging element 24 coupled to or integral with the load 40, and a complementary receiving element 26 coupled to or integral with the retaining strap 10. In this manner, attachment means 22 may allow selective and releasable actuation of the retaining strap 10 with respect to a load 40 and/or associated carrier 60.

An engaging element 24 may comprise, for example, a hook, a screw, a bolt, a latch, a cinch, hook and loop material, a magnet, or any other engaging device known to those in the art. An engaging element 24 in accordance with the present invention may be integral to a load 40, or attached thereto. According to certain embodiments of the present invention, an engaging device 24 may be selectively implemented at a variety of locations on a load 40 so as to customize a relationship between the load 40 and a securing bar 62.

A receiving element 26 may comprise an aperture, hook and loop material, a magnet, or any other device complementary to an engaging element 24 and capable of securing a retaining strap 10 to a load 40 as disclosed herein. According to certain embodiments of the present invention, a receiving element 26 may comprise adjustment means in the form of apertures 20 capable of allowing varying tension between the engaging element 24 and receiving element 26. This feature ensures stability between the load 40 and any of a variety of carriers 60 when the engaging and receiving elements 24 and 26 are properly adjoined.

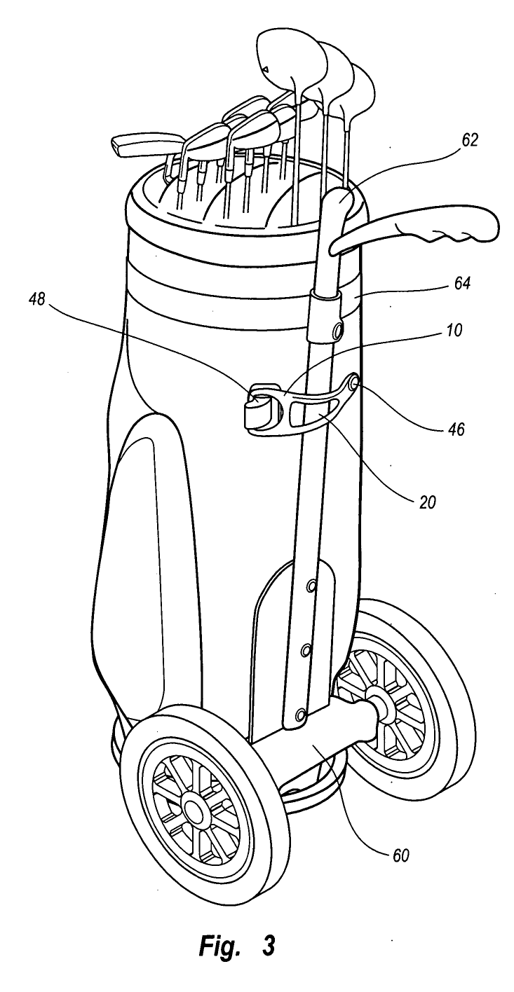

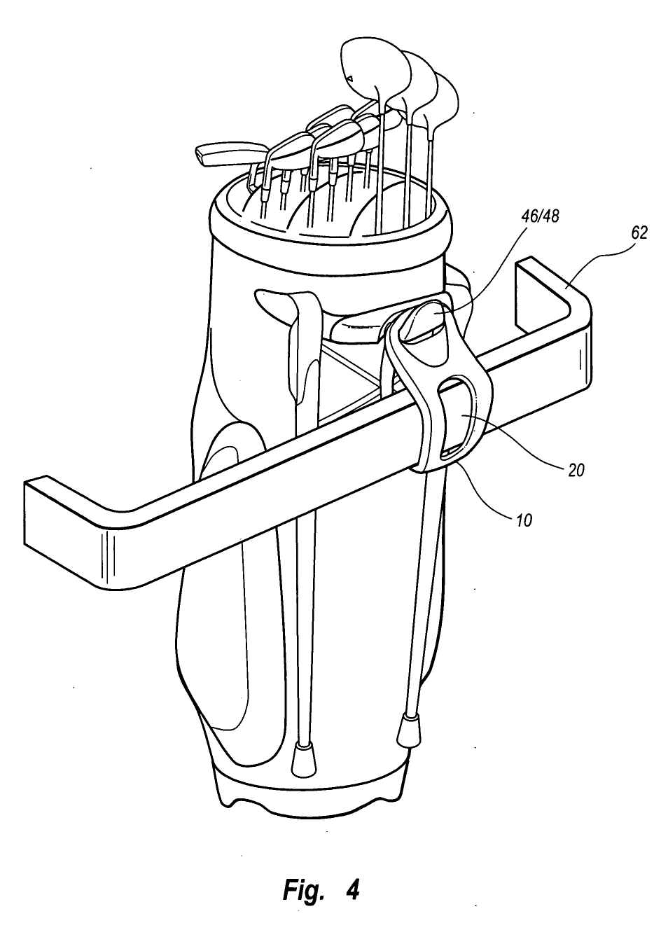

Referring now to FIG. 2, a load 40 may be stabilized with respect to an associated carrier 60 according to a three step process. First, a first end 30 of a retaining strap 10 may be coupled to the load 40 by engaging a receiving element 26 located thereon to an engaging element 24 at a first point of attachment 46. Next, the retaining strap 10 may be directed over a stabilizing bar 62 of an associated carrier. In certain embodiments of the present invention, as illustrated in FIG. 2, the retaining strap 10 is directed upwards from a first point of attachment 46 corresponding to a position below a horizontally disposed securing bar 62 to a second point of attachment 48 corresponding to a position above the same securing bar 62. In alternative embodiments, as depicted in FIG. 3, the retaining strap 10 is directed laterally from a first point of attachment 46 to a second point of attachment 48 to accommodate a vertically disposed securing bar 62. In still other alternative embodiments of the present invention, as depicted in FIG. 4, the retaining strap 10 is directed to entirely circumscribe the securing bar 62 of an associated carrier 60 such that a first point of attachment 46 corresponds to a second point of attachment 48. Finally, the retaining strap 10 is secured at the second point of attachment 48, thereby stabilizing the load 40 against the securing bar 62.

Once secured, the retaining strap 10 of the present invention functions to stabilize the load 40 with respect to its carrier 60 by limiting rotational and lateral movement of the load 40 within the securing straps 64 or other securing mechanism provided by or attached to the associated carrier 60. In this manner, content 50 shifting within an open load 40 may be reduced, and balance maintained between a load 40 and carrier 60.

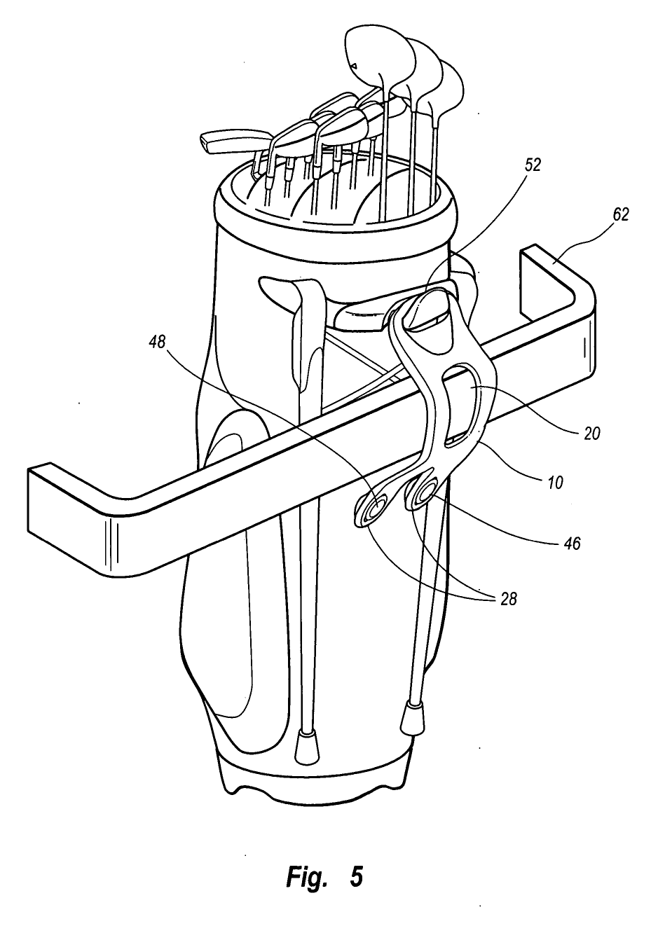

Referring now to FIG. 5, a retaining strap 10 in accordance with the present invention may be secured at more than two points of attachment to further restrict movement between a load 40 and carrier 60. Specifically, at least one end of a retaining strap 10 may diverge into a plurality of fastening legs 28 corresponding to multiple points of attachment. In one embodiment, the first end 30 of the retaining strap 10 diverges into two fastening legs 28 which are permanently attached to the load 40 at two points of attachment. The second end 32 of the retaining strap 10 is releasable and may be selectively secured to a third point of attachment 52 removed from the first two points of attachment such that a securing bar 62 may be retained therebetween.

According to one aspect of the present invention, the structural integrity of the fastening legs 28 may be reinforced by laterally connecting them to form a triangle or other geometric shape at one end of the retaining strap 10. Alternatively, both ends 14 may diverge into fastening legs 28 and all fastening legs 28 may be interconnected to result in a retaining strap 10 having a geometric appearance distinct from the previously disclosed elongate shape. By delimiting a greater surface area in this manner, the retaining strap 10 may function to significantly restrict movement between a load 40 and carrier 60 without compromising its internal strength and elasticity.

What is claimed is:

1. A device for securing a golf bag to a bar on a golf cart, said device comprising:
a principle and a secondary point of attachment coupled to said golf bag;
a retaining strap with a semi-fixed end and a detachable end; and
said semi-fixed end removably coupled to said principle point of attachment and said detachable end capable of passing around said bar of said golf cart and attaching to said secondary point of attachment to retain said bag and prevent said bag from rotating.

2. The device of claim 1, wherein said semi-fixed end is integral with said golf bag.

3. The device of claim 1, wherein said principle and secondary points of attachment are integral with said golf bag.

4. The device of claim 1, wherein said detachable end is a textured pull tab to facilitate gripping said retaining strap.

5. The device of claim 1, wherein said retaining strap is made of a material selected from the group consisting of metal, plastic, rubber, leather, and cloth.

6. The device of claim 1, wherein at least one aperture is formed within said retaining strap to give flexibility to said strap and to allow said at least one aperture to be removably coupled to said secondary point of attachment, enabling said retaining strap to be tightened around said bar of said golf cart.

7. The device of claim 1, wherein said principle and secondary points of attachment are roughly located at common point on said golf bag.

8. A device for securing a golf bag to a bar of a golf cart, said device comprising:
at least one point of attachment coupled to said golf bag;
a retaining strap capable of passing around said bar of said golf cart; and
said retaining strap having at least one fastening leg removably coupled to said at least one point of attachment to retain said bag and to prevent said bag from rotating.

9. The device of claim 8, wherein said retaining strap is integral with said golf bag.

10. The device of claim 8, wherein said at least one point of attachment is integral with said golf bag.

11. The device of claim 8, wherein said at least one fastening leg is a textured pull tab to facilitate gripping said retaining strap.

12. The device of claim 8, wherein at least one aperture is formed within said retaining strap to give flexibility to said strap and to allow said at least one aperture to be removably coupled to said at least one point of attachment, enabling said retaining strap to be tightened around said bar of said golf cart.

13. A device for securing a golf bag to a bar on a golf cart, said device comprising:
attachment means coupled to said golf bag;
stabilizing means capable of passing around said bar of said golf cart; and
said stabilizing means removably coupled to said attachment means to retain said bag and to prevent said bag from rotating.

14. The device of claim 13 wherein said attachment means is integral with said golf bag.

15. The device of claim 13 wherein said stabilizing means is integral with said golf bag.

16. The device of claim 13 wherein said stabilizing means is textured to facilitate gripping said stabilizing means.

17. The device of claim 13 wherein said attachment means includes adjustment means to allow said stabilizing means to be tightened around said bar on said golf cart.

18. A device for securing a golf bag to a bar on a golf cart, said device comprising:
at least one engagement element coupled to said golf bag;
a retaining strap capable of passing around said bar of said golf cart; and
said retaining strap having at least one receiving element removably coupled to said at least one engagement element to retain said bag and to prevent said bag from rotating.

19. The device of claim 18, wherein said at least one engagement element is integral with said golf bag.

20. The device of claim 18, wherein said retaining strap is integral with said golf bag.

21. The device of claim 18, wherein said receiving element is a textured pull tab to facilitate gripping said retaining strap.

22. The device of claim 18, wherein at least one aperture is formed within said retaining strap to give flexibility to said strap and to allow said at least one aperture to be removably coupled to said at least one engagement element, enabling said retaining strap to be tightened around said bar of said golf cart.

23. A device for securing a load to a bar of a carrier, said device comprising:
at least one point of attachment coupled to said load;
a retaining strap capable of passing around said bar of said carrier; and
said retaining strap having at least one fastening leg removably coupled to said at least one point of attachment to retain said load and to prevent said load from rotating.

24. The device of claim 23, wherein said retaining strap is integral with said load.

25. The device of claim 23, wherein said at least one point of attachment is integral with said load.

26. The device of claim 23, wherein said at least one fastening leg is a textured pull tab to facilitate gripping said retaining strap.

27. The device of claim 23, wherein at least one aperture is formed within said retaining strap to give flexibility to said strap and to allow said at least one aperture to be removably coupled to said at least one point of attachment, enabling said retaining strap to be tightened around said bar of said carrier.
